(19) United States
(12) Patent Application Publication
(10) Pub. No.: US 2020/0117341 A1
(43) Pub. Date: Apr. 16, 2020

(54) Method and apparatus for controlling application icon

(71) Applicant: Netmarble Corporation, Seoul (KR)

(72) Inventors: Sun Keun Shim, Seoul (KR); Hye Jeung Jeung, Seoul (KR); Jeong Pil Cheon, Seoul (KR)

(21) Appl. No.: 16/601,568

(22) Filed: Oct. 14, 2019

(30) Foreign Application Priority Data
Oct. 16, 2018 (KR) 10-2018-0123165

(51) Int. Cl. G06F 3/0481; G06F 3/0484; H04M 1/725

(52) U.S. Cl. CPC G06F 3/04817; H04L 67/306; H04M 1/72519; G06F 3/04842

(57) ABSTRACT

Disclosed is a method and apparatus for controlling an application icon. A method of controlling an application icon of an application to be performed by a user terminal includes receiving, from a server, a control signal including a change request for changing the application icon and change type information, changing a form of the application icon based on the change type information in response to the change request being received, and displaying an application icon of the changed form.

### CROSS-REFERENCE TO RELATED APPLICATION(S)

This application claims the priority benefit of Korean Patent Application No. 10-2018-0123165 filed on Oct. 16, 2018, in the Korean Intellectual Property Office, the disclosure of which is incorporated herein by reference for all purposes.

### BACKGROUND

### 1. Field

One or more example embodiments relate to a method and apparatus for controlling an application icon.

### 2. Description of Related Art

Information associated with a program provided through an application may be provided to a user in a form of a push message or be verified only when a user directly executes the application.

When a user restricts a display of a push message through settings of a user terminal of the user, the user may not obtain or verify information associated with a program provided through the push message. When such program-related information is about system maintenance or inspection, the user may execute a corresponding application, and recognize a situation in which an access to the program, for example, a game, is currently restricted through information provided through the application. In such a case, the user may need to perform an unnecessary operation due to such a situation in which information associated with the application is not obtained in advance.

### SUMMARY

According to an example embodiment, there is provided a method of controlling an application icon to be performed by a user terminal, the method including receiving, from a server, a control signal including a change request for changing an application icon of an application and change type information, changing a form of the application icon based on the change type information in response to the change request being received, and displaying an application icon of the changed form.

The change type information may be determined based on state information indicating a state in which an access to the application is restricted. The changing may include changing an application icon of a basic form for the application to an application icon corresponding to the state in which the access is restricted. The changed application icon may indicate therein a progress rate of the state in which the access is restricted.

The change type information may include second change type information to be determined based on event information provided in a program corresponding to the application. The changing may include changing the form of the application icon based on the second change type information.

The change type information may include third change type information to be determined based on situational information associated with a progress of a content of a program provided through the application. The changing may include changing the form of the application icon based on the third change type information.

The change type information may include fourth change type information to be determined based on user account information for the application. The changing may include changing the form of the application icon based on the fourth change type information.

The changing may include displaying, in the application icon, a text predetermined based on the change type information.

The changing may include displaying, in the application icon, an image predetermined based on the change type information.

The image may include an image corresponding to a game character of a user, and the changing may include changing an image object displayed in the application icon to the image corresponding to the game character.

The image may include an image of which a shape changes based on a time limit of an event proceeding in a program provided through the application. The image of which the shape changes may be displayed in an area adjacent to the application icon.

According to another example embodiment, there is provided a method of controlling an application icon to be performed by a server, the method including generating a control signal including a change request for changing an application icon of an application and change type information, in response to a preset condition being satisfied, and providing the generated control signal to a user terminal.

In response to state information of the application being changed, the generating of the control signal may include generating the control signal based on the state information.

In response to an event provided in a program corresponding to the application being initiated, the generating of the control signal may include generating the control signal based on event information associated with the event.

In response to a predetermined content being initiated in a program provided through the application, the generating of the control signal may include generating the control signal based on situational information associated with a progress of the content.

The generating of the control signal may include generating the control signal based on user account information for the application.

According to still another example embodiment, there is provided a server including a communicator and a processor. In response to a preset condition being satisfied, the processor may generate a control signal including a change request for changing an application icon of an application and change type information, and provide the generated control signal to a user terminal.

According to yet another example embodiment, there is provided a user terminal including a communicator configured to communicate with a server, and a processor. The communicator may receive, from the server, a control signal including a change request for changing an application icon of an application and change type information. In response to the change request being received, the processor may change a form of the application icon based on the change type information, and display an application icon of the changed form through a display.

The change type information may be determined based on state information indicating a state in which an access to the application is restricted. The processor may change an application icon of a basic form for the application to an application icon corresponding to the state in which the access is restricted. The changed application icon may indicate therein a progress rate of the state in which the access is restricted.

In response to a preset condition being satisfied, the server may generate the control signal including the change request for changing the application icon of the application and the change type information, and provide the generated control signal to the user terminal.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of an overall operation of a system for controlling an application icon according to an example embodiment;

FIG. 2 is a diagram illustrating an example of a configuration of a system for controlling an application icon according to an example embodiment;

FIG. 3 is a diagram illustrating an example of a configuration of a network of a system for controlling an application icon according to an example embodiment;

FIG. 4 is a flowchart illustrating an example of a method of controlling an application icon to be performed by a user terminal according to an example embodiment;

FIGS. 5A and 5B are diagrams illustrating examples of an application icon changed by a method of controlling an application icon according to an example embodiment;

FIG. 6 is a flowchart illustrating an example of a method of controlling an application icon to be performed by a server according to an example embodiment;

FIG. 7A is a diagram illustrating an example of changing an application icon while an application is operating according to an example embodiment;

FIG. 7B is a diagram illustrating an example of changing an application icon when the number of accesses to a program by a user through an application is relatively less according to an example embodiment;

FIG. 7C is a diagram illustrating an example of changing an application icon when there is no access to a program by a user through an application for a relatively long period of time according to an example embodiment;

FIG. 8 is a diagram illustrating an example of a configuration of a user terminal according to an example embodiment; and

FIG. 9 is a diagram illustrating an example of a configuration of a server according to an example embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

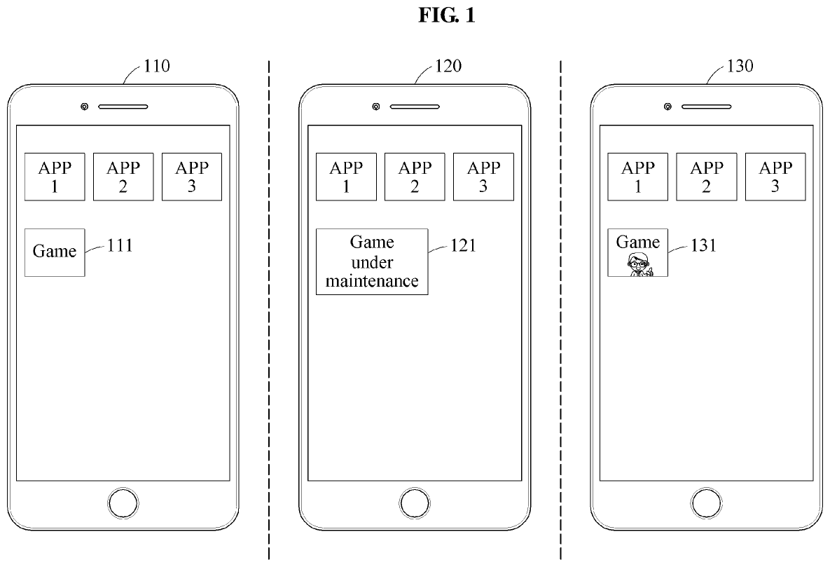

FIG. 1 is a diagram illustrating an example of an overall operation of a system for controlling an application icon according to an example embodiment. Hereinafter, a system for controlling an application icon according to an example embodiment will be simply referred to as an application icon controlling system, an apparatus for controlling an application icon according to an example embodiment will be simply referred to as an application icon controlling apparatus. In addition, a method of controlling an application icon according to an example embodiment will be simply referred to as an application icon controlling method.

Referring to FIG. 1, an application icon controlling system may provide information associated with an application to a user terminal, for example, user terminals 110, 120, and 130, by changing a form of an application icon of the application.

In the example of FIG. 1, the user terminal 110 displays an application icon 111 of an initial state.

The user terminal 120 displays an application icon 121 of a changed form when an application system is under maintenance or inspection. The application icon 121 displays therein a text indicating that the system is currently under maintenance.

The user terminal 130 displays an application icon 131 in which a game character of a user is displayed. The application icon controlling system may thus provide information about the game character of the user through the application icon 131.

The application icon controlling system may provide various sets of information associated with an application through an application icon of a changed form, for example, the application icons 121 and 131, without a need to execute the application, and provide the information without a push message. Thus, a user may obtain the various sets of information through the changed application icon without a need to perform an additional operation.

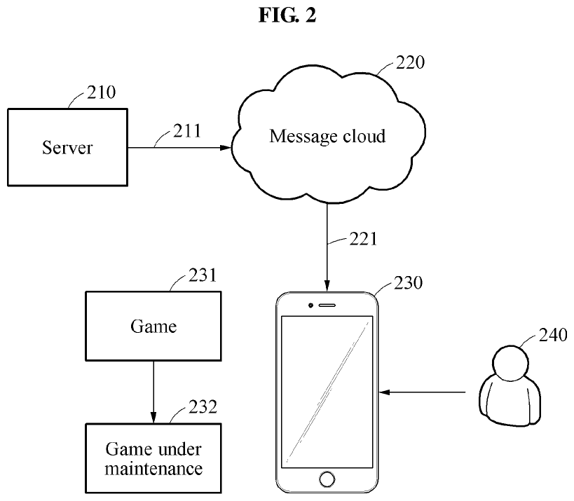

FIG. 2 is a diagram illustrating an example of a configuration of an application icon controlling system according to an example embodiment.

Referring to FIG. 2, an application icon controlling system includes a server 210 configured to generate a control signal that changes an application icon of an application, and a user terminal 230. The server 210 may generate the control signal and provide the generated control signal to the user terminal 230. The control signal may be a signal with an extremely small load to be applied to the server 210. In the illustrated example, the server 210 sends a request for providing the control signal to a message cloud 220 in an operation indicated by an arrow 211, and the message cloud 220 transfers the control signal to the user terminal 230 in an operation indicated by an arrow 221. The user terminal 230 changes an application icon 231 of a basic form to an application icon 232 of a form that provides certain information based on the control signal, and then displays the application icon 232 of the changed form.

However, when the application is not executed or run in the user terminal 230, or executed or run in the background, the user terminal 230 may execute the application temporarily and change a form of the application icon of the application, based on the control signal. As illustrated, a user 240 verifies information associated with the application through the application icon 232 of the changed form without executing the application.

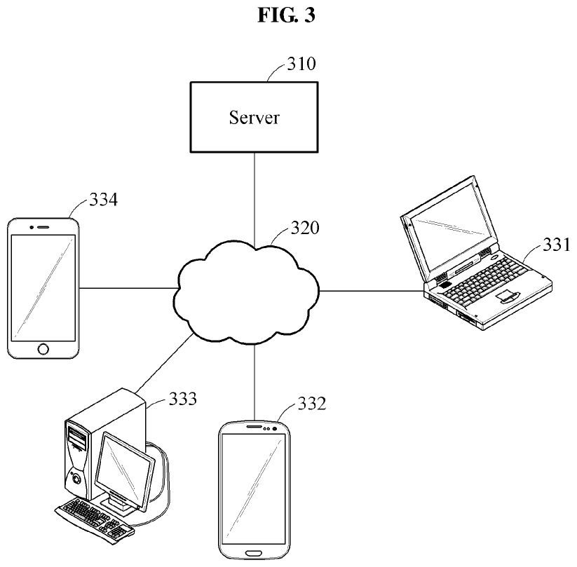

FIG. 3 is a diagram illustrating an example of a configuration of a network of an application icon controlling system according to an example embodiment.

Referring to FIG. 3, an application icon controlling system includes a server 310 and a plurality of user terminals 331, 332, 333, and 334, which are connected through a communication network 320, for example, the Internet. The server 310 may also be referred to as a web server, and provide an online service to the user terminals 331, 332, 333, and 334 through the communication network 320, for example, the Internet.

The user terminals 331, 332, 333, and 334 may be configured to perform a communication function, and connected to or have access to the server 310 through the communication network 320. The user terminals 331, 332, 333, and 334 may be one of various electronic devices that are generally used by general users today, for example, a smartphone, a personal computer (PC), a tablet PC, a laptop computer, and the like. However, examples of a user terminal are not limited to what has been described in the foregoing as an example, and include other communication devices. The user terminals 331, 332, 333, and 334 may have a client program installed therein, and be connected to the server 310 through the client program.

In the illustrated example, the server 310 generates a control signal that changes an application icon of an application in the user terminals 331, 332, 333, and 334 based on a preset condition, and transmits the generated control signal to the user terminals 331, 332, 333, and 334. The user terminals 331, 332, 333, and 334 change a form of the application icon based on the received control signal, and displays the application icon of the changed form. The user terminals 331, 332, 333, and 334 provide a user with information associated with the application through the application icon of the changed form.

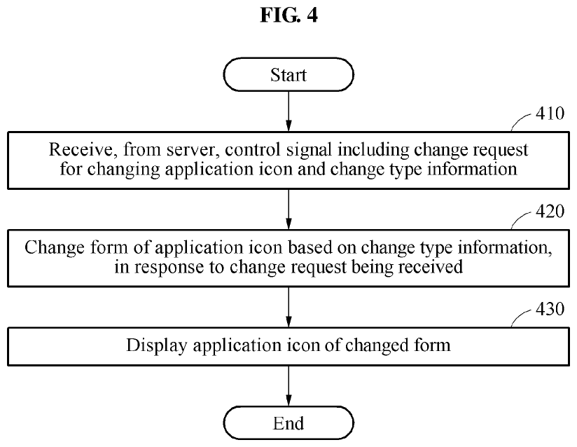

FIG. 4 is a flowchart illustrating an example of an application icon controlling method to be performed by a user terminal according to an example embodiment.

Referring to FIG. 4, in operation 410, a user terminal receives, from a server, a control signal including a change request for changing an application icon of an application and change type information. The control signal may also include information associated with a resource path through which a text or an image corresponding to a change type or method is obtained.

In operation 420, when the user terminal receives the change request through the control signal, the user terminal changes a form of the application icon based on the change type information.

The change type information may be determined based on information associated with the application to be provided to a user through the changing of the form of the application icon.

The change type information may include first change type information to be determined based on state information of an application, and the user terminal may change a form of the application icon based on the first change type information.

The state information of an application may include various sets of information associated with a current state of the application. The state information of an application may indicate a state of the application, for example, a state in which an application system is currently under maintenance or inspection, or a state in which an access is restricted due to, for example, server overload.

The change type information may include second change type information to be determined based on event information provided in a program corresponding to an application, and the user terminal may change a form of the application icon based on the second change type information.

The event information may be information associated with an event that is additionally provided besides a content generally provided in a program corresponding to an application. The event may include, for example, an event of providing a special reward for an access to a game program, an event of providing a chance to purchase a certain item at a reduced price, and the like.

The change type information may include third change type information to be determined based on situational information associated with a progress of a content of a program provided through an application, and the user terminal may change a form of the application icon based on the third change type information.

The situational information may be information indicating a progress of a content provided in a program corresponding to an application. For example, when a game application corresponds to a game of constructing various buildings or structures and trading the constructed buildings or structures, the situational information may include, for example, information indicating a progress of a content of constructing a building in the current game program, and information indicating a progress of a content of trading the constructed building in the current game program. The situational information may also include various sets of information, for example, information associated with a situation in which a character of a user is leveled up, information associated with a situation in which a character of a user is killed during a hunt, and the like, according to an application.

The change type information may also include fourth change type information to be determined based on user account information for an application, and the user terminal may change a form of the application icon based on the fourth change type information.

The account information may be information associated with a user account of a user registered for the application. The account information may include, for example, character information corresponding to the user account, information associated with a type and a number of items possessed by the user account, information associated with a ranking of the user account, and the like.

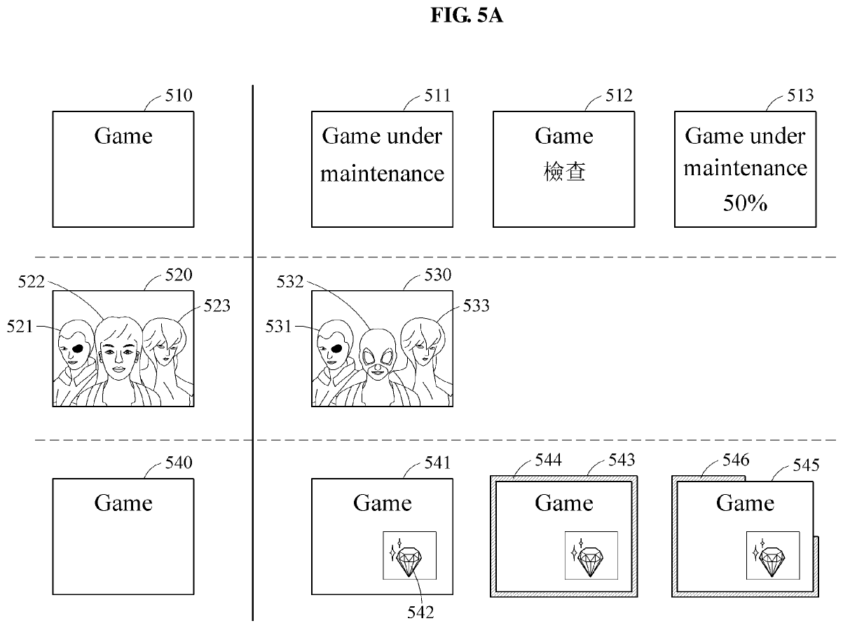

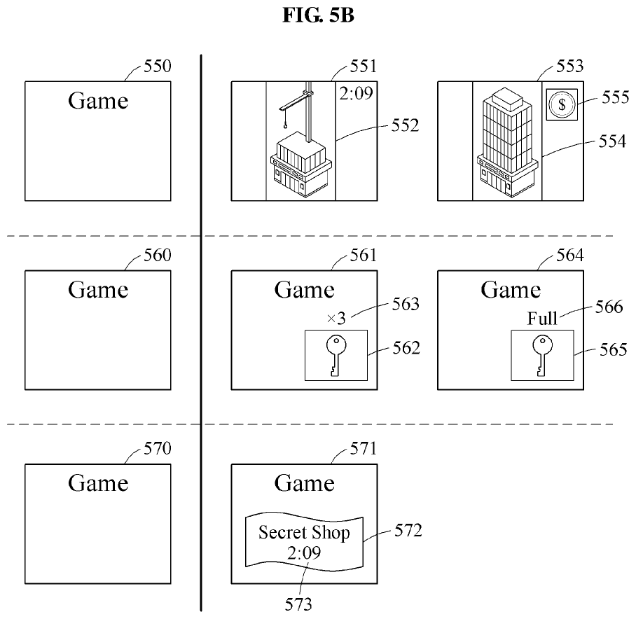

As described above, the user terminal may change the form of the application icon based on the change type information. In detail, the user terminal may display, in the application icon, a text or an image predetermined based on the change type information. Hereinafter, examples of how an application icon changes will be described in greater detail with reference to FIGS. 5A and 5B. However, a detailed change method is not limited to the examples to be described hereinafter, and may include a method of changing a form of an application using a text or an image.

In operation 430, the user terminal displays the application icon of the changed form through a display.

FIGS. 5A and 5B are diagrams illustrating examples of an application icon changed by an application icon controlling method according to an example embodiment.

FIG. 5A illustrates application icons 510, 511, 512, and 513 of which forms are changed based on change type information that is determined based on state information of an application.

Referring to FIG. 5A, a user terminal changes the application icon 510 of a basic form to the application icons 511, 512, and 513 of a form that indicates or displays therein a text, based on a control signal received from a server. The application icon 511 displays a text “under maintenance” corresponding to state information indicating a state of a system maintenance inspection, based on a change type or method determined through the state information. In addition, according to an example, a text corresponding to the state information that is indicated in a foreign language may be displayed in the application icon 512. In addition, a text “50%” corresponding to a progress rate of the maintenance may be indicated or displayed in the application icon 513.

In addition, FIG. 5A illustrates application icons 520 and 530 of which forms are changed based on change type information that is determined through user account information.

Referring to FIG. 5A, the application icon 520 is of a basic form indicating a plurality of characters 521, 522, and 523. A user terminal changes the application icon 520 to the application icon 530 based on change type information determined through user account information. In detail, the user terminal changes the character 522 included in the application icon 520 to an image 532 corresponding to a game character of a user obtained through the user account information. The application icon 530 generated as a result may be of a form including characters 531 and 533 already existing in the application icon 520 and the image 532 corresponding to the game character of the user. For example, when a user account includes a plurality of game characters, the characters 531 and 533 may also be changed based on the game characters possessed by the user.

In addition, FIG. 5A illustrates application icons 540, 541, 543, and 545 of which forms are changed based on change type information that is determined through event information.

Referring to FIG. 5A, when an event of providing a diamond is initiated in a game program, the application icon 540 of a basic form is changed to the application icon 541 in which an image 542 indicating the initiation of the event is indicated.

In addition, the application icon 540 is changed to application icons 543 and 545 including an image indicating event information and an image indicating time information associated with the event. The application icon 543 displays an image 544 indicating a time limit of the event in a nearby area, and a length of the image 544 is reduced as a time elapses. The application icon 543 is then changed to the application icon 545 including an image 546 with the reduced length.

FIG. 5B illustrates application icons 550, 551, and 553 of which forms are changed based on change type information that is determined based on situational information associated with a progress of a content of a game program.

Referring to FIG. 5B, the application icon 550 corresponds to a game application of constructing a building in a city and trading the constructed building. When a content of constructing a building proceeds based on a progress of a game program, the application icon 550 is changed to the application icon 551 of a form including an image 552 corresponding to a situation in which the building is being constructed. The application icon 551 further includes a text “2:09” corresponding to time information associated with a time for which the current situation is maintained additionally.

When the building is completely constructed after a time required to construct the building elapses, the application icon 551 is changed to the application icon 553 including an image 554 indicating a situation in which the building is completely constructed and an image 555 indicating that a preparation for the content of trading the building is completed.

In addition, FIG. 5B illustrates application icons 560, 561, and 564 of which forms are changed based on change type information that is determined based on item possession information of user account information.

Referring to FIG. 5B, when a preset condition is satisfied, the application icon 560 is changed to the application icon 561 or the application icon 564. The preset condition may include, for example, a condition that a user completes an account linking process, a condition that a user accesses a program within a preset time, and the like. The application icon 561 includes an image 562 indicating possession of an item corresponding to a key and an image 563 indicating the number of possessed items corresponding to the key. The application icon 564 includes an image 565 indicating the possession of the item corresponding to the key and an image 566 indicating that the number of possessed items corresponding to the key reaches a maximum number of possession.

In addition, FIG. 5B illustrates application icons 570 and 571 of which forms are changed based on change type information that is determined based on event information.

Referring to FIG. 5B, when an event of opening a secret shop is initiated in a program provided through an application, the application icon 570 is changed to the application icon 571. The application icon 571 includes an image 572 indicating event information associated with the event, and a text 573 providing information associated with a time at which the event is initiated.

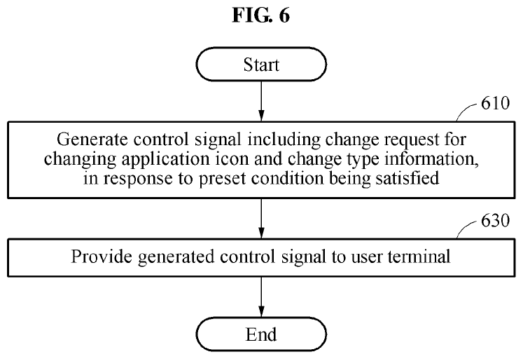

FIG. 6 is a flowchart illustrating an example of an application icon controlling method to be performed by a server according to an example embodiment.

Referring to FIG. 6, in operation 610, when a preset condition is satisfied, a server generates a control signal including a change request for changing an application icon of an application and change type information.

When state information of the application is changed, the server may generate a control signal based on the state information. For example, when an application system maintenance or inspection is initiated, the server may determine change type information based on state information corresponding to the application system maintenance or inspection, and generate a control signal based on the determined change type information.

When an event provided in a program corresponding to the application is initiated, the server may generate a control signal based on event information associated with the event. For example, when an event of providing a certain item at a reduced price is initiated in a program, the server may determine change type information based on event information associated with the event, and generate a control signal based on the determined change type information.

When a predetermined content is initiated in a program provided through the application, the server may generate a control signal based on situational information associated with a progress of the content. For example, when the application is a game application of constructing a building in a city, and a content of constructing a building proceeds in a game program, the server may determine change type information based on situational information associated with a current situation of the content, and generate a control signal based on the determined change type information. In this example, an application icon to be generated through the determined change type information may provide information associated with a progress, for example, a progress of constructing a building, through an image or a text.

In addition, the server may generate a control signal based on user account information for the application. For example, when a user links a user account to the application, the server may determine change type information based on the user account information, for example, character information and possessed item information, and generate a control signal based on the determined change type information.

In operation 630, the server provides the generated control signal to a user terminal.

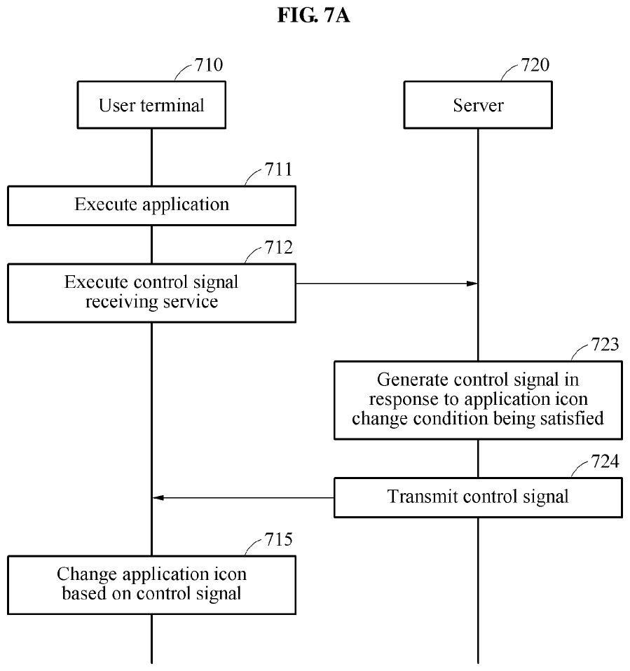

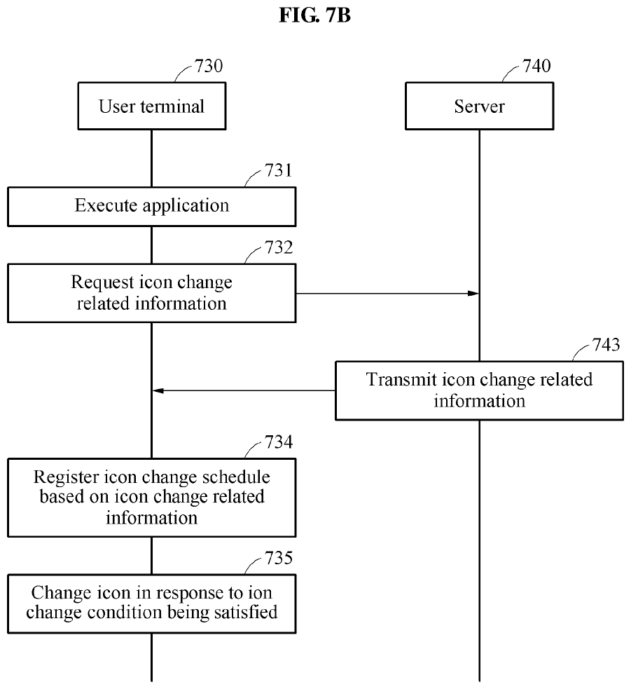

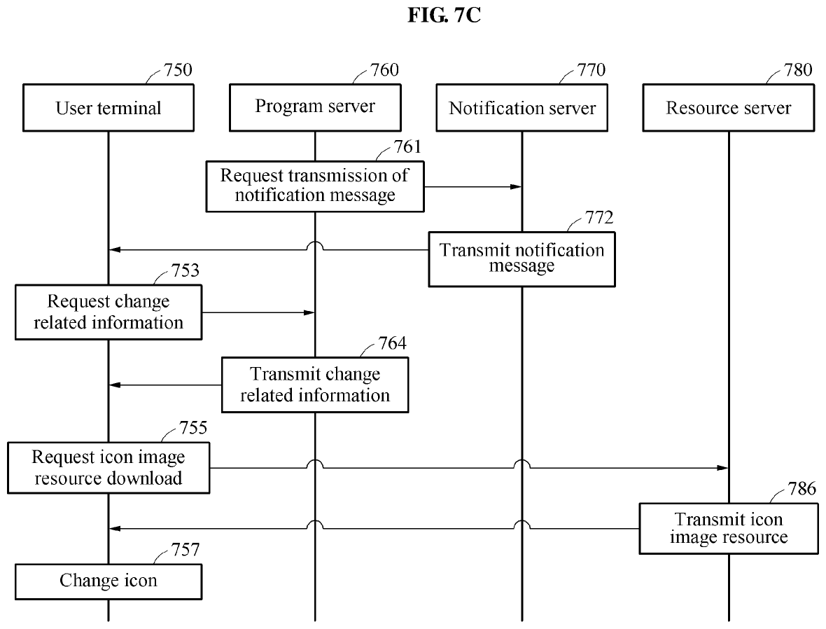

FIG. 7A is a diagram illustrating an example of changing an application icon while an application is operating according to an example embodiment.

Referring to FIG. 7A, in operation 711, an application is executed in a user terminal 710.

In operation 712, the user terminal 710 executes a control signal receiving service and accesses a server 720.

In operation 723, when a condition for changing an application icon of the application is satisfied, the server 720 generates a control signal. In operation 724, the server 720 transmits the generated control signal to the user terminal 710. The condition for changing an application icon may include a situation, for example, when a game character of is leveled up, when a game character is killed in a battle, when an application system maintenance or inspection is initiated, when an event is initiated in a program, and the like.

In operation 715, the user terminal 710 changes a form of the application icon based on the control signal.

FIG. 7B is a diagram illustrating an example of changing an application icon when the number of accesses to a program by a user through an application is relatively less according to an example embodiment.

Referring to FIG. 7B, in operation 731, an application is executed in a user terminal 730.

In operation 732, the user terminal 730 sends, to a server 740, a request for information associated with changing an application icon of the application. The information associated with changing an application icon may include, for example, information associated with a preset condition for changing the application icon, change type information, information associated with a duration or time to be maintained, and information associated with a resource path of an image of the application icon. The preset condition may include, for example, changing state information of the application (e.g., system maintenance or inspection), initiating a content (e.g., content of constructing a building), linking a user account, initiating an event, and the like.

The server 740 transmits, to the user terminal 730, the information associated with changing the application icon in operation 743, and the user terminal 730 registers an icon change schedule for changing the application icon based on the received information in operation 734. For example, the user terminal 730 may register the icon change schedule by matching change type information corresponding to each of an application system maintenance or inspection time and an event initiation time.

In operation 735, when such application icon change condition is satisfied, for example, when the application system maintenance or inspection time registered in the icon change schedule arrives, the user terminal 730 changes a form of the application icon based on the matching change type information.

FIG. 7C is a diagram illustrating an example of changing an application icon when there is no access to a program by a user through an application for a relatively long period of time according to an example embodiment.

Referring to FIG. 7C, when there is no access to a program for a relatively long period of time, information associated with the program may not be present in a user terminal 750.

In operation 761, a program server 760 sends, to a notification server 770, a message transmission request for transmitting a notification message. Here, the notification message may have a same target as a control signal.

In response to the message transmission request, the notification server 770 transmits the notification message to the user terminal 750 through a message cloud in operation 772.

The user terminal 750 temporarily executes an application based on the notification message, and sends a request for information associated with changing an application icon to the program server 760 in operation 753.

In response to the request, the program server 760 transmits the information associated with changing the application icon to the user terminal 750 in operation 764.

The user terminal 750 obtains information associated with an icon image resource path based on the information associated with changing the application icon, and sends a request for downloading an icon image resource to a resource server 780 in operation 755.

In response to the request, the resource server 780 transmits the icon image resource to the user terminal 750 in operation 786, and the user terminal 750 changes a form of the application icon of the application based on the icon image resource in operation 757.

Although it is illustrated in FIG. 7C that the program server 760, the notification server 770, and the resource server 780 are provided as separate components, they may operate as a single server to perform the operations described above with reference to FIG. 7C.

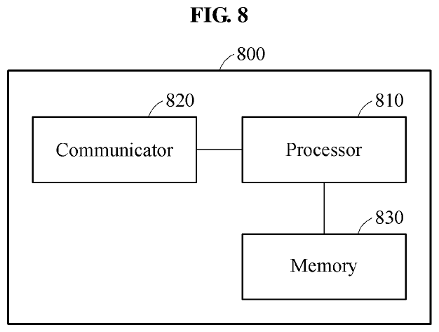

FIG. 8 is a diagram illustrating an example of a configuration of a user terminal according to an example embodiment.

Referring to FIG. 8, a user terminal 800 includes a communicator 820 configured to communicate with a server, a processor 810, and a memory 830.

The communicator 820 may receive, from the server, a control signal including a change request for changing an application icon of an application and change type information.

The processor 810 may control an overall operation of the user terminal 800, and perform one or more operations or methods described herein in relation to a user terminal.

When the processor 810 receives the change request, the processor 810 may change a form of the application icon based on the change type information, and display the application icon of the changed form through a display (not shown).

The processor 810 may change the form of the application icon based on the change type information which is determined based on state information of the application, and display the application icon of the changed form through the display. The change type information may be determined based on, for example, situational information associated with a progress of a content, event information, and user account information, in addition to the state information.

In addition, the processor 810 may change the form of the application icon based on a text or an image corresponding to the change type information.

In addition, the user terminal 800 may perform the application icon controlling method described above in relation to a user terminal.

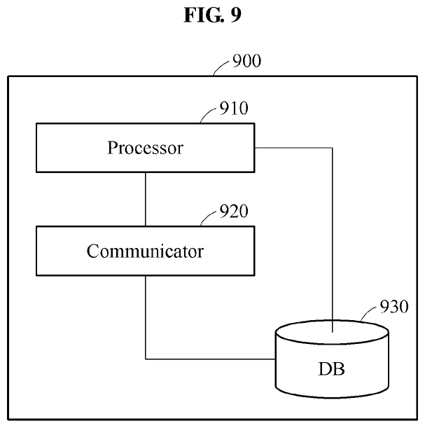

FIG. 9 is a diagram illustrating an example of a configuration of a server according to an example embodiment.

Referring to FIG. 9, a server 900 includes a communicator 920 configured to communicate with a user terminal, a processor 910, and a database (DB) 930.

The processor 910 may control an overall operation of the server 900, and perform one or more operations or methods described herein in relation to a server. According to an example embodiment, when a preset condition is satisfied, the processor 910 may generate a control signal including a change request for changing an application icon of an application and change type information, and the communicator 920 may provide the generated control signal to the user terminal.

When state information of the application changes, the processor 910 may generate the control signal based on the changed state information.

In addition, the server 900 may perform the application icon controlling method described above in relation to a server.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of controlling an application icon to be performed by a user terminal, the method comprising:
receiving, from a server, a control signal including a change request for changing an application icon of an application and change type information;
in response to the change request being received, changing a form of the application icon based on the change type information; and
displaying an application icon of the changed form.

2. The method of claim 1, wherein the change type information is determined based on state information indicating a state in which an access to the application is restricted, and
the changing comprises:
changing an application icon of a basic form for the application to an application icon corresponding to the state in which the access is restricted,
wherein the changed application icon indicates therein a progress rate of the state in which the access is restricted.

3. The method of claim 1, wherein the change type information includes second change type information to be determined based on event information provided in a program corresponding to the application,
wherein the changing comprises:
changing the form of the application icon based on the second change type information.

4. The method of claim 1, wherein the change type information includes third change type information to be determined based on situational information associated with a progress of a content of a program provided through the application,
wherein the changing comprises:
changing the form of the application icon based on the third change type information.

5. The method of claim 1, wherein the change type information includes fourth change type information to be determined based on user account information for the application,
wherein the changing comprises:
changing the form of the application icon based on the fourth change type information.

6. The method of claim 1, wherein the changing comprises:
displaying, in the application icon, a text predetermined based on the change type information.

7. The method of claim 1, wherein the changing comprises:
displaying, in the application icon, an image predetermined based on the change type information.

8. The method of claim 7, wherein the image includes an image corresponding to a game character of a user,
wherein the changing comprises:
changing an image object displayed in the application icon to the image corresponding to the game character.

9. The method of claim 7, wherein the image includes an image of which a shape changes based on a time limit of an event proceeding in a program provided through the application,
wherein the image of which the shape changes is displayed in an area adjacent to the application icon.

10. A method of controlling an application icon to be performed by a server, the method comprising:
in response to a preset condition being satisfied, generating a control signal including a change request for changing an application icon of an application and change type information; and
providing the generated control signal to a user terminal.

11. The method of claim 10, wherein the change type information is determined based on state information indicating a state in which an access to the application is restricted,
wherein the user terminal is configured to change an application icon of a basic form for the application to an application icon corresponding to the state in which the access is restricted,
wherein the changed application icon indicates therein a progress rate of the state in which the access is restricted.

12. The method of claim 10, wherein the generating of the control signal comprises:
in response to state information of the application being changed, generating the control signal based on the state information.

13. The method of claim 10, wherein the generating of the control signal comprises:
in response to an event provided in a program corresponding to the application being initiated, generating the control signal based on event information associated with the event.

14. The method of claim 10, wherein the generating of the control signal comprises:
in response to a predetermined content being initiated in a program provided through the application, generating the control signal based on situational information associated with a progress of the content.

15. The method of claim 10, wherein the generating of the control signal comprises:
generating the control signal based on user account information for the application.

16. A non-transitory computer-readable storage medium storing instructions that, when executed by a processor, cause the processor to perform the method of claim 1.

17. A user terminal comprising:
a communicator configured to communicate with a server; and
a processor,
wherein the communicator is configured to receive, from the server, a control signal including a change request for changing an application icon of an application and change type information, and
the processor is configured to:
change a form of the application icon based on the change type information, in response to the change request being received, and
display, through a display, an application icon of the changed form.

18. The user terminal of claim 17, wherein the change type information is determined based on state information indicating a state in which an access to the application is restricted,
wherein the processor is configured to change an application icon of a basic form for the application to an application icon corresponding to the state in which the access is restricted,
wherein the changed application icon indicates therein a progress rate of the state in which the access is restricted.

19. The user terminal of claim 17, wherein the processor is configured to change the form of the application icon based on a text or an image corresponding to the change type information.

20. The user terminal of claim 17, wherein, in response to a preset condition being satisfied, the server is configured to generate the control signal including the change request for changing the application icon and the change type information, and provide the generated control signal to the user terminal.
